(19) United States
(12) Patent Application Publication
(10) Pub. No.: US 2020/0022780 A1
(43) Pub. Date: Jan. 23, 2020

(54) Denture Removal Tools

(71) Applicant: Robert W. Bryant, Colorado Springs, CO (US)

(72) Inventor: Robert W. Bryant, Colorado Springs, CO (US)

(21) Appl. No.: 16/504,047

(22) Filed: Jul. 5, 2019

Related U.S. Application Data
(60) Provisional application No. 62/700,651, filed on Jul. 19, 2018.

(51) Int. Cl. A61C 3/00

(52) U.S. Cl. CPC A61C 3/00

(57) ABSTRACT

A tool and set thereof providing for relatively easy removal of dentures is described. At least one embodiment comprises a set of tools: one for removal of an upper denture; and a second for removal of a lower denture. Each are characterized by a cylindrical shaft that has a flat or facet formed near its distal end that tapers towards the distal end thinning the shaft. The tip is bent to about a 90 degree angle. The thin tip can be easily maneuvered over a lip of a denture and as necessary in-between the denture lip and the underlying gum. The user holding onto the handle on the proximal end of the tool can push, pull, leverage and rotate the tip to pop the denture loose for removal.

### BACKGROUND

Modern dentures are held in place by a series of posts that are implanted in the tooth bed and snappily receive a corresponding coupling attachment that is secured to the back side of an associated set of upper or lower dentures. When snapped in place, the dentures are secured to the posts and the corresponding upper and lower jaw. While this connection is far superior to traditional dentures that use a bridge and an adhesive to hold a set of dentures in place, they can be challenging to remove. It can be difficult for denture users to reach around the lip of the denture and pull the denture free from the securing posts. This difficulty is exacerbated for elderly patients, who make up the majority of denture users, because of their reduced dexterity.

### BRIEF DESCRIPTION OF THE DRAWINGS

FIG. 1 is an isometric illustration of a first set of denture removal tools including one tool for removing an upper denture and another tool for removing a lower denture according to a first embodiment of the present invention.

FIG. 2a is a close-up isometric view of the tip of the upper denture removal tool of FIG. 1 according to the first embodiment of the present invention.

FIG. 2b is a close-up isometric view of the tip of the lower denture removal tool of FIG. 1 according to the first embodiment of the present invention.

FIG. 3a is an isometric illustration of a second set of denture removal tools including one tool for removing an upper denture and another tool for removing a lower denture according to a second embodiment of the present invention.

FIG. 3b is an isometric illustration of a third set of denture removal tools including one tool for removing an upper denture and another tool for removing a lower denture according to a third embodiment of the present invention.

FIGS. 4a&b are illustrations demonstrating the use of upper and lower denture removal tools respectively for removing upper and lower dentures from the mouth according to an embodiment of the present invention.

FIG. 5 is a cross sectional view of a shaft of a tool prior to the bending of the tip according to one embodiment of the present invention.

### DETAILED DESCRIPTION

Embodiments of the present invention provide for relatively easy removal of dentures especially those using modern dentures that are held in place by firmly coupling with posts anchored into the jaw. At least one embodiment comprises a set of tools: one for removal of an upper denture; and a second for removal of a lower denture. Each are characterized by a cylindrical shaft that has a flat or facet formed near its distal end that tapers towards the distal end. The tip is bent to about a 75-110 degree angle. The thin tip can be easily maneuvered over a lip or edge of a denture and as necessary in-between the denture edge and the underlying gum. The user holding onto the handle on the proximal end of the tool can push, pull, leverage and rotate the tip to pop the denture loose for removal.

The upper denture removal tool is characterized by a substantially straight shaft with the afore described bent tip. The lower denture removal tool is characterized by a longer shaft that proximate its distal end is formed into a downwardly facing U with the faceted sided of bent tip facing generally upwardly. As can be appreciated, the shape of the tool's shaft facilitates its ease of use. To remove the upper denture, the upper denture removal tool is placed over the upper lip of the denture and the denture is pulled downwardly by a user holding onto the handle. In contrast, to remove the lower denture, the lower denture removal tool is placed underneath the lower lip of the denture and the denture is pushed upwardly by a user holding onto the handle.

In at least some embodiments the handles are made relatively large to facilitate easy gripping by elderly person who might have reduced dexterity and/or other ailments, such as arthritis, that would inhibit holding a smaller sized handle or shaft.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment”, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The terms “approximately” and “substanitally” as used in this specification and appended claims, refers to plus or minus 10% of the value given.

The terms “about” and “generally” as used in this specification and appended claims, refers to plus or minus 20% of the value given.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of a Set of Denture Removal Tools

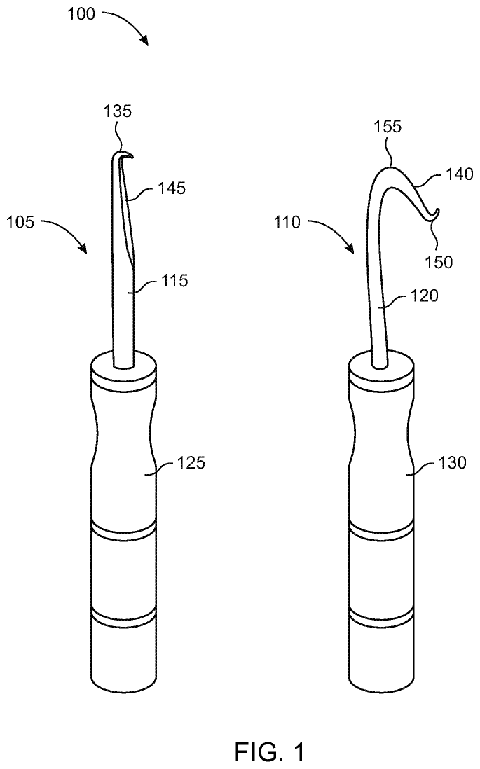

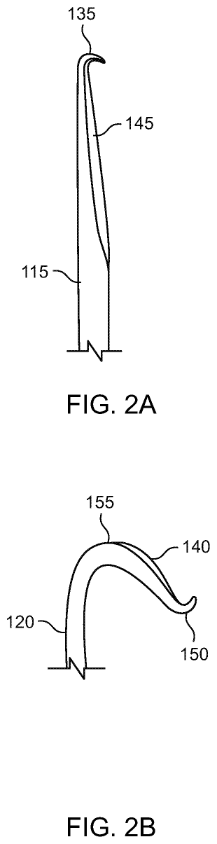

A first embodiment of a set of first and second denture removal tools 105 & 110 is illustrated in FIGS. 1, 2A & 2B. Most simply, each tool comprises a specifically-formed shaft 115 & 120 with a bent tip end 135 & 150 that is attached to a handle 125 & 130 that can be held by a person to manipulate the tool to facilitate the removal of an upper or lower denture. The shaft of the first denture removal tool 105 used in removing upper dentures is substantially straight; whereas, the second tool 110 for removing lower dentures includes a generally U-shaped curve/bend 155.

The handles 125&130 can be best seen in FIG. 1. Each handle is typically cylindrical and can include a tapered section near its distal end to act as a thumb rest. The handle is typically made of a plastic material but variations can be made of other materials as well, such as wood. In at least some variations, the handle can be coated or covered in a rubber or elastomeric sleeve to enhance a user's grip thereon. The diameter of the handle can vary but in at least some variations is has a diameter of at least 0.65″ making it easier to grip for elderly persons who may have arthritis or other dexterity issues.

The shaft 115&120 is typically comprised of a formed cylindrical metal rod having a longitudinal axis comprising the cylindrical center of the rod. The diameter as well as the metal comprising the shaft can vary but a shaft diameter is typically about 0.15-0.25″. In at least one embodiment, the shaft is comprised of an aluminum alloy, although other variations are known that comprise stainless steel shafts. The length of the shafts can vary especially as well especially between the first and second tool configurations. Most notably, the second tool configured for the removal of lower dentures has a longer shaft than the first tool configured for removal of upper dentures largely because of the incorporation of the downwardly facing U-shaped bend 155 in the second tool.

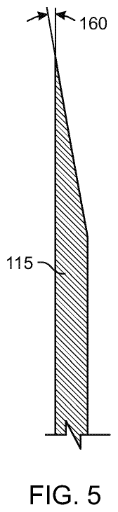

As can be best seen in FIGS. 2A & 2B, a facet 140&145 (or flat surface) is formed on one side of the shaft generally proximate and extending to the shaft's distal end. The facet is formed at an angle relative to the shafts longitudinal axis thereby causing the thickness of the shaft to taper from the beginning of the facet to the distal end of the shaft 115&120. The geometry of the shaft facet 145 is best shown in the cross sectional view of FIG. 5 on a distal portion of a shaft 115 that has not had a tip formed thereon. The face of the facet forms a shallow acute angle 160 with the longitudinal axis of the shaft. The extent of the angle can vary but is typically about 10-25 degrees.

The formation of the facet 140&145 and the associated tapering of the shaft facilitates the formation of an effective tip 135&150 that can easily be maneuvered over or under the lip of a denture to assist in prying or popping it loose. The tips 135&150 of the first and second denture tools are best shown in FIGS. 2A & 2B. About 0.10-0.25″ in length of the shaft at its distal end is bent or otherwise formed into a tip that makes an angle relative to the adjacent longitudinal axis of the shaft of about 75-110 degrees and more preferably an angle of 85-95 degrees.

Essentially, the flat face of the facet 140&145 provides a surface on the tip for making better contact with the edge or lip of the associated denture permitting a greater and more effective removal force to be applied. Further, the thinness of the tip allows the user to more easily wedge it underneath the edge of the denture to help facilitate removal as necessary. In symbiotic contrast, the side of the shaft on the tip opposite the facet is typically rounded, which allows a user to pivot the tip about the curved surface to enhance leverage against the denture in coaxing it loose.

As shown best in FIG. 1, except for the tip 135 the shaft 115 of the first tool 105 is substantially straight. In contrast, however, the distal portion of the shaft terminating in the tip 150 of the second tool 110 is formed into a generally downwardly shaped “U” 155 such that the facet 140 is facing upwardly and outwardly as is the tip. More specifically, the distal portion of the shaft including the tipped distal end is bent along a radius relative to the proximal portion of the shaft to form about a 50-90 degree angle with the proximal portion. Accordingly, as seen for instance in FIG. 2, the tip projects upwardly and outwardly from the proximal portion of the shaft at an angle of about 0-40 degrees. This positioning facilitates its use in removing a lower denture.

### Other Embodiments of Sets of Denture Removal Tools

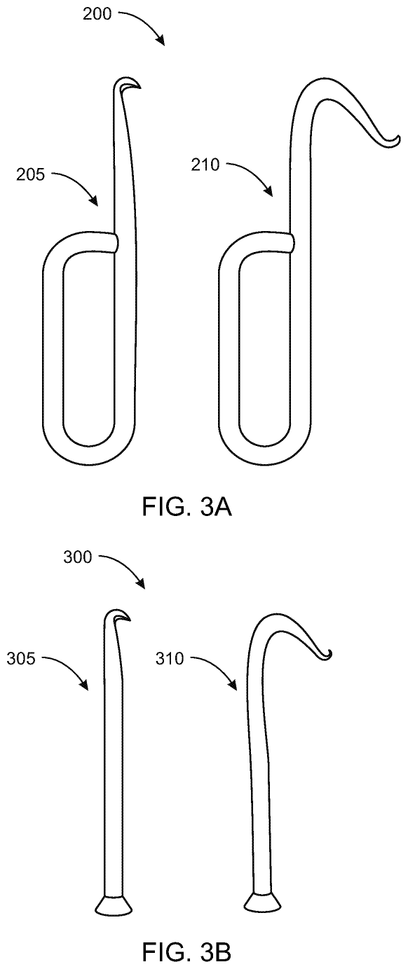

FIGS. 3A & 3B illustrate other variations of the denture removal tools. Most notability, the tools differ concerning their handles. Generally, the design and configuration of the tips and distal portions of the shafts of the variations are substantially similar to those described with reference to the first embodiment.

The first illustrated variation comprises first and second tools 205 & 210 wherein the elongated shafts are bent around to form handles. In the second illustrated variation 305 & 310, the shaft itself comprises the handle. A base is provided on each of the tubes to allow a user to stand them up vertically. The base can comprise an elastomeric piece that can be secured to a surface by suction.

### A Method of Using a Set of Denture Removal Tools

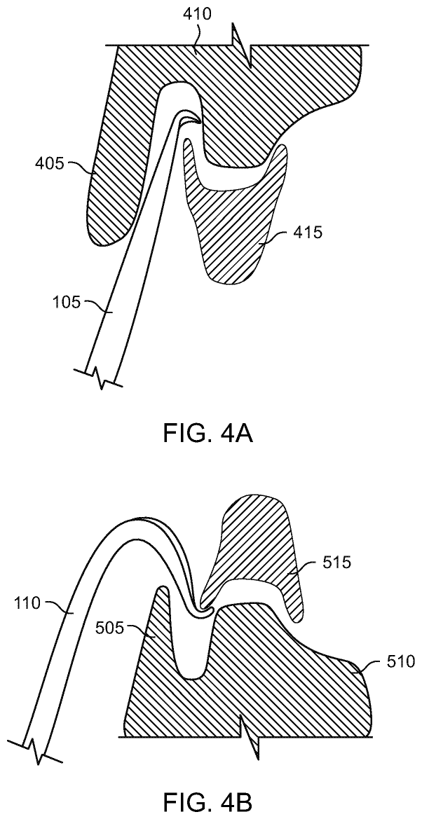

Methods of using the denture removal tools to remove upper and lower dentures are described with reference to FIGS. 4A & 4B.

To remove an upper denture 415, especially of the type held in place by way of posts secured in the user's jaw, the first tool 105 with its straight shaft is typically used. The tip 135 of the tool is placed vertically in the user's mouth between the cheek 405 and the upper jaw 410 on one side of the mouth. The tip is maneuvered until the flat side 145 (or facet side) of the tip rests on the top lip or edge of the side of the denture. The user gripping the handle 125 pulls downwardly on the tool. He may also cant the tool by rotating the tool outwardly away from the face to wedge the tip between the jaw tissue and the denture. Ideally, the applied force breaks the denture free of its mount on at least the side to which the tool was applied. Typically, once one or more posts on one side of the mouth are removed, the user can reach in and easily remove the upper denture with his hands. However, in instances where this still may be difficult, the user can move the tool over to the other side of the mouth and repeat the process further separating the denture from other posts.

To remove a lower denture 515, the second tool 110 is used. The tip 150 of the tool is placed vertically in the user's mouth between the cheek 505 and the lower jaw 510 on one side of the mouth. The tip is maneuvered until the flat side 140 (or facet side) of the tip rests on the bottom lip or edge of the side of the denture 515. The user gripping the handle 130 pushes upwardly on the tool. He may also cant the tool by rotating the tool outwardly away from the face to wedge the tip between the jaw tissue and the denture. Ideally, the applied force breaks the denture free of its mount on at least the side to which the tool was applied. Typically, once one or more posts on one side of the mouth are removed, the user can reach in and easily remove the lower denture with his hands. However, in instances where this still may be difficult, the user can move the tool over to the other side of the mouth and repeat the process further separating the denture from other posts.

### Variations and Other Embodiments

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A tool for removing dentures from a mouth, the tool comprising an elongated cylindrical shaft having distal and proximal ends, the shaft including a longitudinal axis with a facet formed on a side of the shaft proximate and extending to its distal end, the facet forming an acute angle with the longitudinal axis tapering a thickness of the shaft as it extends towards the distal end along the facet, the distal end including a tip, the tip being formed at an angle of about 75-95 degrees relative to an adjacent portion of the longitudinal axis with a portion of the facet on the tip facing a portion of the facet on a remainder of the shaft.

2. The tool of claim 1, further comprising a handle affixed to a proximal end.

3. The tool of claim 2, wherein the handle is generally cylindrical and has a diameter of at least 0.65″.

4. The tool of claim 3, wherein the handle is comprised of plastic.

5. The tool of claim 1, wherein the shaft is comprised of an aluminum alloy.

6. A set of first and second tools of claim 1.

7. The tool of claim 1, wherein the shaft is substantially straight.

8. The tool of claim 1, wherein the shaft an upper portion of the shaft is formed into a U-shape with the facet and tip facing outwardly relative to the remainder of the shaft.

9. The set of claim 6 wherein the first tool has a shaft that is substantially straight and the second tool has a shaft wherein the upper portion of the shaft is formed into a U-shape with the facet and tip facing outwardly relative to the remainder of the shaft.

10. A method of using the tool of claim 7 to remove an upper denture, the method comprising:
while holding the tool proximate a proximal end of the shaft, placing the tip over a top edge of the upper denture adjacent to the gum on one of the left and right side of the upper jaw while orientating the shaft generally downwardly; and
pulling the tool downwardly until the upper denture is freed from the one of the left and right side of the jaw.

11. The method of claim 10, further comprising:
placing the tip over the top edge of the upper denture adjacent to the gum on the other of the left and right side of the upper jaw while orientating the shaft generally downwardly; and
pulling the tool downwardly until the upper denture is freed from the other of the left and right side of the upper jaw.

12. A method of using the tool of claim 8 to remove a lower denture, the method comprising:
while holding the tool proximate a proximal end of the shaft, placing the tip under a bottom edge of the lower denture adjacent to the gum on one of the left and right side of the lower jaw while orientating the proximal end generally downwardly; and
pushing the tool upwardly until the lower denture is freed from the one of the left and right side of the lower jaw.

13. The method of claim 12, further comprising:
placing the tip under the bottom edge of the denture adjacent to the gum on the other of the left and right side of the lower jaw while orientating the proximal end of the shaft generally downwardly; and
pushing the tool upwardly until the lower denture is freed from the other of the left and right side of the lower jaw.

14. A tool for removing dentures from a mouth, the tool comprising:
an elongated cylindrical shaft having distal and proximal ends, the shaft being comprised of an aluminum alloy and including a longitudinal axis with a facet formed on a side of the shaft proximate and extending to its distal end, the facet forming an acute angle with the longitudinal axis tapering a thickness of the shaft as it extends towards the distal end along the facet, the distal end including a tip, the tip being formed at an angle of about 75-95 degrees relative to an adjacent portion of the longitudinal axis with a portion of the facet on the tip facing a portion of the facet on a remainder of the shaft; and
a generally cylindrical handle comprised of plastic secured to a proximal end of the shaft, the handle being comprised of plastic and having a diameter of at least 0.65″.

15. The tool of claim 14, wherein the shaft an upper portion of the shaft is formed into a U-shape with the facet and tip facing outwardly relative to the remainder of the shaft.

16. A set comprising an upper denture removal tool and a lower denture removal tool wherein:
the upper denture removal tool comprises,
an elongated substantially straight cylindrical shaft having distal and proximal ends, the shaft including a longitudinal axis with a facet formed on a side of the shaft proximate and extending to its distal end, the facet forming an acute angle with the longitudinal axis tapering a thickness of the shaft as it extends towards the distal end along the facet, the distal end including a tip, the tip being formed at an angle of about 75-95 degrees relative to an adjacent portion of the longitudinal axis with a portion of the facet on the tip faceting a portion of the facet on a remainder of the shaft, and
a generally cylindrical handle comprised of plastic secured to a proximal end of the shaft, the handle being comprised of plastic; and
the lower denture removal tool comprises,
an elongated cylindrical shaft having distal and proximal ends, the shaft including a longitudinal axis with a facet formed on a side of the shaft proximate and extending to its distal end, the facet forming an acute angle with the longitudinal axis tapering the thickness of the shaft as it extends towards the distal end along the facet, the distal end including a tip, the tip being formed at an angle of about 75-95 degrees relative to an adjacent portion of the longitudinal axis with a portion of the facet on the tip faceting a portion of the facet on a remainder of the shaft, and
a generally cylindrical handle comprised of plastic secured to a proximal end of the shaft, the handle being comprised of plastic

17. The set of claim 9 wherein the handles of each of the upper and lower denture removal tools has a diameter of at least 0.65″.
